(19) United States
(12) Patent Application Publication
(10) Pub. No.: US 2024/0168192 A1
(43) Pub. Date: May 23, 2024

(54) Shot Point Dithering Techniques for Marine Seismic Surveys

(71) Applicant: PGS Geophysical AS, Oslo (NO)

(72) Inventors: Christian Strand, Weybridge (GB); Edwin Thomas Hodges, Woking (GB)

(73) Assignee: PGS Geophysical AS, Oslo (NO)

(21) Appl. No.: 18/390,415

(22) Filed: Dec. 20, 2023

Related U.S. Application Data
(63) Continuation of application No. 17/254,132, filed on Dec. 18, 2020, now abandoned.
(60) Provisional application No. 62/807,987, filed on Feb. 20, 2019.
(60) Provisional application No. 62/688,091, filed on Jun. 21, 2018.

(51) Int. Cl. G01V 1/38; G01V 1/00

(52) U.S. Cl. CPC G01V 1/3808; G01V 1/005; G01V 1/3861; G01V 1/3843; G01V 2210/127; G01V 2210/1293

(57) ABSTRACT

Techniques are disclosed relating to performing marine surveys according to dither values generated based on one or more dithering constraints. This may include for example, determining a set of nominal shot points for a marine seismic energy source and determining dither values for ones of the nominal shot points. In some embodiments, the dither values are randomly generated, subject to a duplication constraint such that at most a threshold number of dither differences between consecutive shot points that fall within discrete ranges. In some embodiments, actual shot points are determined for the planned sail line based on application of the determined dither values to the nominal shot points. In various embodiments, the disclosed techniques may facilitate a separate de-blending procedure to separate signals from the marine seismic energy source and signals from one or more other seismic energy sources to be used for the seismic survey.

### CROSS-REFERENCE TO RELATED APPLICATIONS

This application is a continuation of prior U.S. Non-Provisional patent application Ser. No. 17/254,132, filed on Dec. 18, 2020, which is a 35 USC 371 national stage entry of and claims priority to International Application PCT/EP2019/066447, filed on Jun. 21, 2019, which claims priority to U.S. Provisional Patent Application No. 62/688,091, filed on Jun. 21, 2018 and to U.S. Provisional Patent Application No. 62/807,987, filed on Feb. 20, 2019. All of the aforementioned applications are hereby incorporated by reference as if entirely set forth herein. In the event of a conflict between the meaning of terms as used herein with the same or similar terms as used in any of the aforementioned applications, the meanings associated with this application will control.

### BACKGROUND

Geophysical surveys are often used for oil and gas exploration in geophysical formations, which may be located below marine environments. Various types of signal sources and geophysical sensors may be used in different types of geophysical surveys. Seismic geophysical surveys, for example, are based on the use of acoustic waves. Electromagnetic geophysical surveys, as another example, are based on the use of electromagnetic waves. In marine geophysical surveys, a survey vessel may tow one or more sources (e.g., air guns, marine vibrators, electromagnetic sources, etc.) and one or more streamers along which a number of sensors (e.g., hydrophones and/or geophones and/or electromagnetic sensors) are located.

During the course of a geophysical survey, the various sensors may collect data indicative of geological structures, which may be analyzed, e.g., to determine the possible locations of hydrocarbon deposits. In 4D surveying techniques, surveys may be performed at a given location at different times, e.g., to determine changes to hydrocarbon deposits.

### BRIEF DESCRIPTION OF THE DRAWINGS

FIG. 1 illustrates an exemplary marine geophysical survey system, according to some embodiments.

FIG. 2 illustrates nominal and actual shot positions for three sources during a portion of a seismic survey, according to some embodiments.

FIG. 3A illustrates an example difference between dither values for two consecutive shot points for a seismic energy source, according to some embodiments.

FIG. 3B illustrates example differences between actual shot times from a set of sources, according to some embodiments.

FIG. 4A is a block diagram illustrating an exemplary method for determining dither values for a set of shot points based on a non-duplication constraint, according to some embodiments.

FIG. 4B is a block diagram illustrating an exemplary method for determining dither values for a set of shot points based on a statistical value constraint, according to some embodiments.

FIG. 5 illustrates an example application of a constraint under which differences between consecutive dithers within a set of shot points cannot fall within the same range, according to some embodiments.

FIG. 6A illustrates example discrete ranges between consecutive shot points according to the constraint discussed with reference to FIG. 5, according to some embodiments.

FIG. 6B illustrates a configuration of nominal distance between shot points and an acceptable dither interval for the shot points of FIG. 6A.

FIGS. 7A and 7B illustrate example probability plots for differences between dither values for consecutive shot points with and without a constraint that absolute differences are greater than a threshold value, respectively.

FIG. 8 illustrates an example probability plot for differences between consecutive dithered shot points with both a dither difference constraint and a standard deviation constraint applied, according to some embodiments.

FIG. 9 illustrates an example probability plot for differences between consecutive dithered shot points with both a dither difference constraint and a non-duplication constraint applied, according to some embodiments.

FIGS. 10A and 10B illustrate example plots of the difference in dither values between consecutive shot points for a single source when no constraints are applied and when multiple constraints are applied, according to some embodiments.

FIG. 11 is a flow diagram illustrating an example method for performing a marine seismic survey using a set of dither values that exhibit a non-duplication constraint such that at most a threshold number of dither differences between consecutive shot points fall within discrete ranges, according to some embodiments.

FIG. 12 is a flow diagram illustrating an example method for determining one or more dither values for a set of nominal shot points based on a non-duplication constraint, according to some embodiments.

FIG. 13 is a block diagram illustrating an example computing device, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. An “apparatus configured to steer a streamer” is intended to cover, for example, a module that performs this function during operation, even if the corresponding device is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be configured to perform that function.

Reciting in the appended claims that a structure is “configured to” perform one or more tasks is expressly intended not to invoke 35 U.S.C. § 112(f) for that claim element. Should Applicant wish to invoke Section 112(f), Applicant will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

### Overview of a Seismic Geophysical Survey

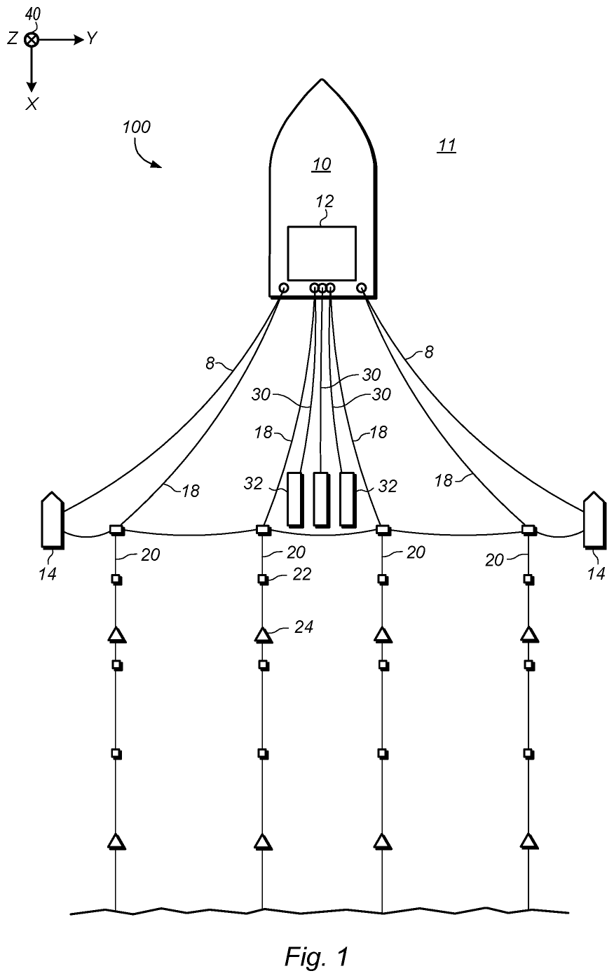

Referring to FIG. 1, an illustration of a marine geophysical survey system 100 is shown (not necessarily to scale), according to some embodiments. In the illustrated embodiment, system 100 includes survey vessel 10, sources 32, source cables 30, paravanes 14, and streamers 20 (streamers 20 are shown truncated at the bottom of FIG. 1). In some embodiments, survey vessel 10 may be configured to move along a surface of a body of water 11 such as a lake or ocean. In the illustrated embodiment, survey vessel 10 tows streamers 20, sources 32, and paravanes 14, which may be used to provide a desired amount of spread among streamers 20. In other embodiments, streamers 20 with sources 32 may be towed by a separate vessel (not shown), rather than survey vessel 10.

In some embodiments, streamers 20 may include sensors 22 (e.g., hydrophones, geophones, electromagnetic sensors, etc.). In other embodiments, streamers 20 may further include streamer steering devices 24 (also referred to as “birds”) which may provide selected lateral and/or vertical forces to streamers 20 as they are towed through the water, typically based on wings or hydrofoils that provide hydrodynamic lift. In some embodiments, streamers 20 may further include tail buoys (not shown) at their respective back ends.

In some embodiments, survey vessel 10 may include equipment, shown generally at 12 and for convenience collectively referred to as a “recording system.” In some embodiments, recording system 12 may include devices such as a data recording unit (not shown separately) for making a record of signals generated by various geophysical sensors. Recording system 12 may also include navigation equipment (not shown separately), which may be configured to control, determine, and record the geodetic positions of: survey vessel 10, sources 32, streamers 20, sensors 22, etc., according to some embodiments. In the illustrated embodiment, streamers 20 are coupled to survey vessel 10 via cables 18.

In the figure, an xy-plane 40 is shown of the Cartesian coordinate system having three orthogonal, spatial coordinate axes labeled x, y and z. The coordinate system is used to specify orientations and coordinate locations within the body of water 11. The x-direction is parallel to the length of the streamer (or a specified portion thereof when the length of the streamer is curved) and/or the tow direction and is referred to as the “in-line” direction. The y-direction is perpendicular to the x-axis and substantially parallel to the surface of the body of water 11 and is referred to as the cross-line direction. The z-direction is perpendicular to the xy-plane (i.e., perpendicular to the surface of the body of water 11) with the positive z-direction pointing downward away from the surface of the body of water.

Collectively, the survey data that is recorded by recording system 12 may be referred to as “marine survey input data”, according to some embodiments. In embodiments where the survey being performed is a seismic survey, the recorded data may be more specifically referred to as “marine survey seismic data,” although the marine survey input data may encompass survey data generated by other techniques. In various embodiments, the marine survey input data may not necessarily include every observation captured by sensors 22 (e.g., the raw sensor data may be filtered before it is recorded). Also, in some embodiments, the marine survey input data may include data that is not necessarily indicative of subsurface geology, but may nevertheless be relevant to the circumstances in which the survey was conducted (e.g., environmental data such as water temperature, water current direction and/or speed, salinity, etc.). In some embodiments, geodetic position (or “position”) of the various elements of system 100 may be determined using various devices, including navigation equipment such as relative acoustic ranging units and/or global navigation satellite systems (e.g., a global positioning system (or “GPS”)).

Various data items relating to geophysical surveying (e.g., raw data collected by sensors and/or marine survey input data generally, or products derived therefrom by the use of post-collection processing such as the techniques discussed below, to the extent these differ in various embodiments), may be embodied in a “geophysical data product.” A geophysical data product may comprise a computer-readable, non-transitory medium having geophysical data stored on the medium, including, e.g., raw streamer data, processed streamer data, two- or three-dimensional maps based on streamer data, or other suitable representations. Some non-limiting examples of computer-readable media may include tape reels, hard drives, CDs, DVDs, flash memory, print-outs, etc., although any tangible computer-readable medium may be employed to create the geophysical data product. In some embodiments, raw analog data from streamers may be stored in the computer-readable media. In other instances, as noted above, the data may first be digitized and/or conditioned prior to being stored in the computer-readable medium. In yet other instances, the data may be fully processed into a two- or three-dimensional map of the various geophysical structures, or another suitable representation, before being stored in the computer-readable medium. The geophysical data product may be manufactured during the course of a survey (e.g., by equipment on a vessel) and then, in some instances, transferred to another location for geophysical analysis, although analysis of the geophysical data product may occur contemporaneously with survey data collection. In other instances, the geophysical data product may be manufactured subsequent to survey completion, e.g., during the course of analysis of the survey.

### Overview of Shot Point Dithering

Traditionally, marine surveys have been performed with nominally uniform spacing between consecutive shot points for a given seismic energy source. Dithering actual shot points relative to nominal spacing, however, may facilitate improvements to deblending procedures that separate signals originating from different sources. In disclosed embodiments, dither values for consecutive shot points are randomly generated subject to one or more constraints. In some embodiments, recorded signals from surveys performed according to disclosed dither values may require less processing to de-blend, or provide better de-blending results, relative to surveys performed using dither values generated by other means.

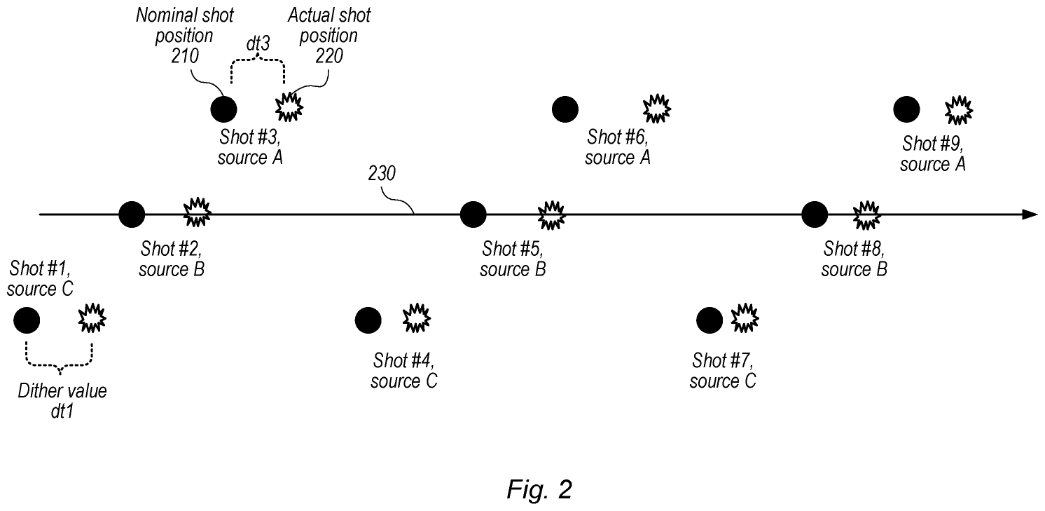

FIG. 2 illustrates nominal and actual shot positions for three sources during a portion of a seismic survey, according to some embodiments. Specifically, FIG. 2 shows three nominal and three actual shot points for each of three sources A, B, and C (a total of 9 nominal and 9 actual shot points) along a sail line 230. In the illustrated embodiment, nominal shot positions 210 are represented by solid dots, while actual shot positions 220 are represented by explosive shapes. In the illustrated embodiment, the distance between the nominal shot position and the actual shot position for each shot is represented using the notation dtn where n is the shot number (e.g., dt1, dt2, etc.). Information specifying this distance is referred to herein as a dither value for a given shot point. Thus, a larger distance between actual and nominal shot positions corresponds to a larger absolute dither value.

In the illustrated embodiment, the nominal shot points for each source are equally spaced in both time and distance, while the distances between actual shot points for each source may differ depending on the dither values for the corresponding shots. As used herein, the difference between the dither values for consecutive shot points for a given source or among a set of sources may be referred to as a “dither difference.” Note that the distance between consecutive actual shot points may reflect this dither difference (e.g., may be determined as the sum of the nominal shot point interval and the dither difference). Note that dither differences may be determined for consecutive shots among various sets of sources. For example, in some embodiments, dither differences are considered for a single source (e.g., shots #1 and #4 of FIG. 2 are consecutive shots for a given source) while in other embodiments dither differences may be considered among consecutive shots from a set of multiple sources. For example, if the set includes the three sources A, B, and C of FIG. 2, then shots #1, #2, and #3 are a sequence of consecutive shots for this set of sources. As another example, if the set includes the lower two sources B and C shown in FIG. 2 then shots #1, #2, #4, and #5 are a sequence of consecutive shots for this set of two sources.

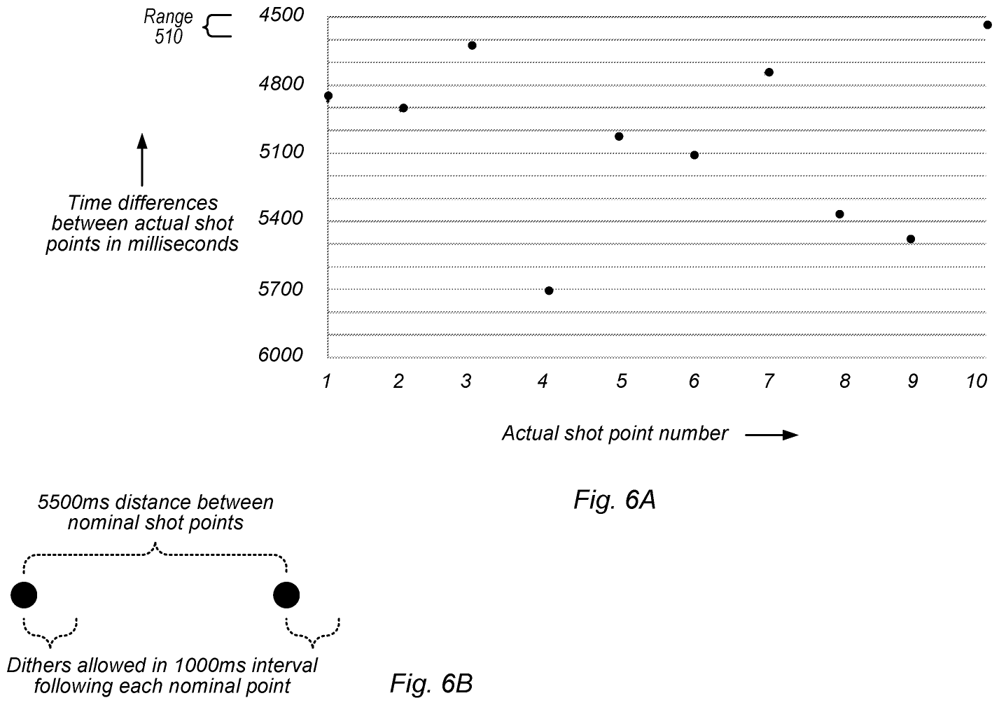

In various embodiments, dither values, dither differences, distances between shot points, etc. may be measured using units of time and/or distance. Specific examples discussed herein (e.g., discussing dither differences in units of time with reference to FIG. 6A below) are included for purposes of illustration but are not intended to limit the scope of the present disclosure. The relationship between time intervals and physical distances may be based on velocity of the seismic survey vessel (and the sources) relative to the ground.

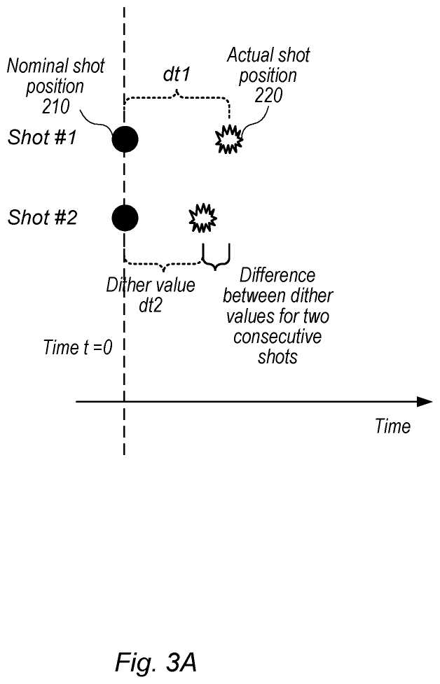

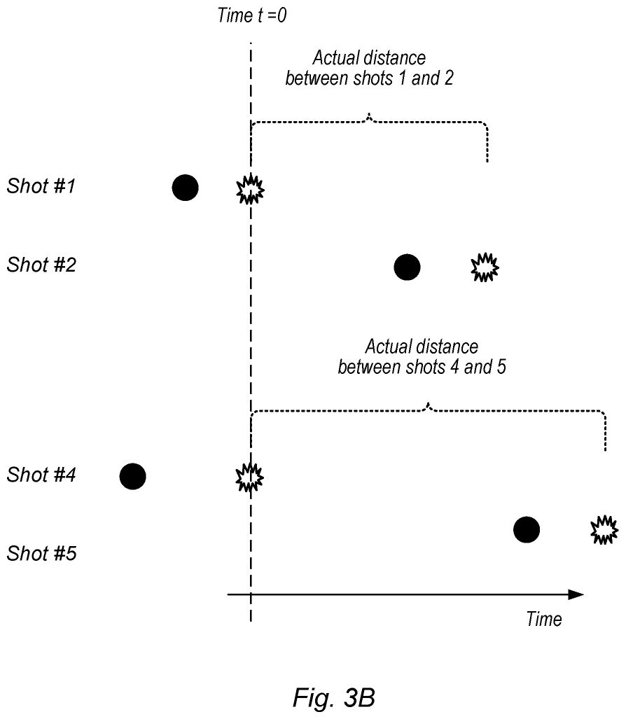

FIG. 3A illustrates an example difference between dither values for two consecutive shot points for a seismic energy source, according to some embodiments. Note that the nominal shot points have been aligned for purposes of illustration (the nominal shot positions for shot #1 and shot #2 are both shown at time t=0), but the nominal shot time for shot #2 is actually later in time than the nominal shot time for shot #1. In the illustrated embodiment, an actual shot position 220 and a nominal shot position 210 are shown for two consecutive shot points #1 and #2 for the same seismic energy source or a set of seismic energy sources. In the illustrated embodiment, the two different nominal shot points for the same source are aligned at a time t=0 (e.g., the time difference between nominal shot points has been removed). In the illustrated embodiment, the dither values dt1 and dt2 for shots #1 and #2 are shown. In the illustrated embodiment, the difference between dither values (e.g., the dither difference) for the two consecutive actual shot points is also shown. Various constraints discussed herein are based on such a dither difference between dithers for consecutive shot points.

FIG. 3B illustrates example differences between actual shot times from a set of sources, according to some embodiments. In the illustrated embodiment, two examples of such distances are shown: the distance between shots #1 and #2 and the distance between shots #4 and #5. These shots may be from the same source or from a set of multiple sources. In FIG. 6B, discussed in further detail below, such distances between actual shot points are plotted for a set of ten shot points.

### Exemplary Dithering Constraints

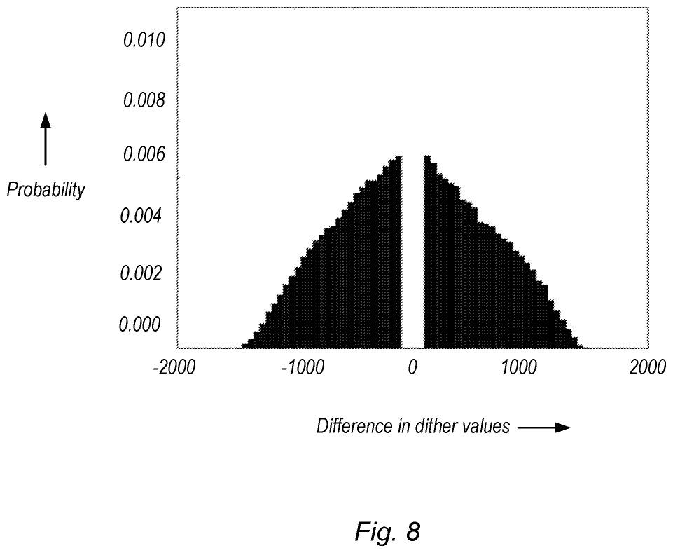

In some embodiments, constraints are applied when determining dither values for a survey. The constraints applied for dither values may include one or more of the following: a predetermined threshold absolute dither difference (e.g., the absolute value of the difference in dither values must be greater than the threshold), a non-duplication constraint for dither differences (e.g., among a set of dither values, at most a threshold number of dither differences between consecutive shots may fall within a given discrete range), and a predetermined standard deviation threshold for dither differences (e.g., the standard deviation for differences in dither values between consecutive shot points must be greater than a predetermined threshold value). Note that various dither constraints discussed herein may be utilized along or in combination with other constraints. Examples of shot points following multiple constraints are discussed below with reference to FIGS. 8-10B.

For the threshold dither difference constraint, referring again to FIG. 3A, the constraint may specify that the absolute difference between dither values for two consecutive shots must always be greater than a threshold value within a set of shot points. In some embodiments, this may prevent dithered shot points from occurring close to the nominal shot point distance, thereby facilitating deblending in the processing of recorded signals and improvement in the generated images. Note that differences between dither values may be negative and the absolute value of the difference may be considered in these scenarios. The threshold value for the absolute differences between dither values for consecutive shot points may be determined based on a threshold signal frequency to be emitted by a seismic energy source over a planned sail line. For example, for a signal frequency threshold of 5 Hz (which has a period of 200 ms), a minimum dither difference of 100 ms for consecutive shot points may be implemented.

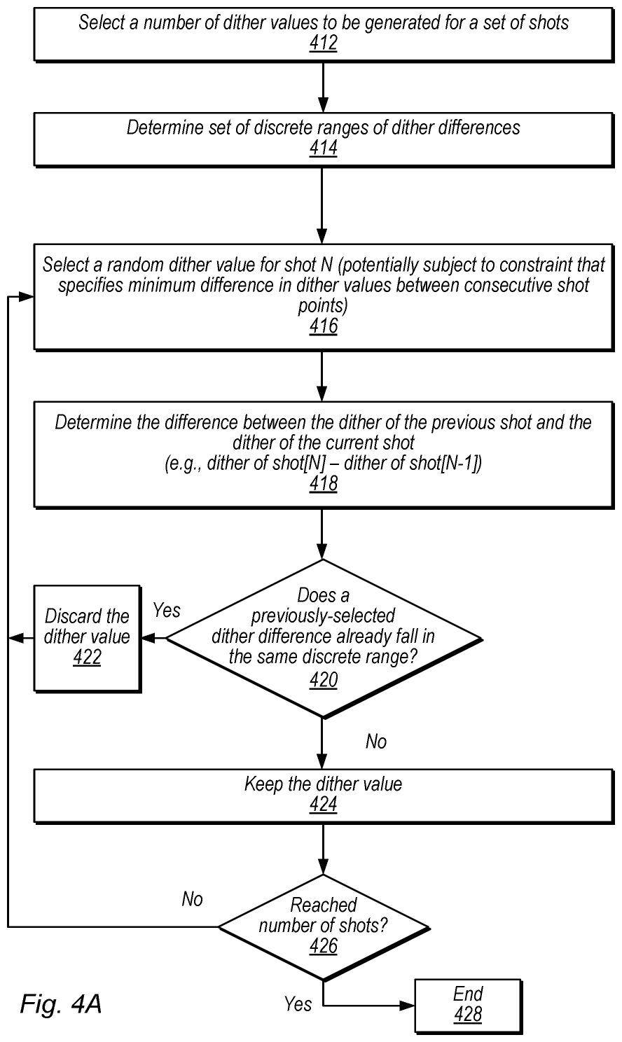

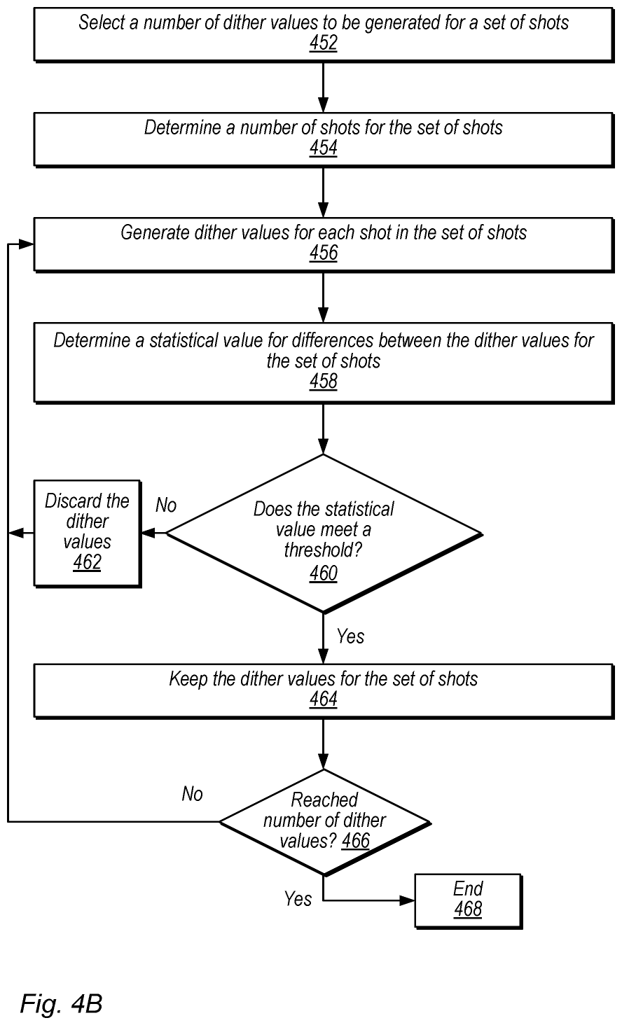

For the non-duplication constraint, among a set of dither values, the constraint may specify that at most a threshold number of dither differences between consecutive shots may fall within a given discrete range. FIG. 4A, discussed in detail below, provides an example in which a non-duplication constraint (which may result in other desirable statistics such as a certain standard deviation among dither differences) is enforced using discrete ranges for dither differences.

For the standard deviation constraint, among a set of shot points, the constraint may specify that the dither differences must have a standard deviation greater than a threshold value. In some embodiments, this may improve the distribution of differences in dither values, which in turn may facilitate improvements to de-blending in processing recorded signals. FIG. 4B, discussed in detail below, provides an example in which a standard deviation constraint is enforced using a statistical value for dither differences.

FIG. 4A is a block diagram illustrating an exemplary method for determining dither values for a set of shot points based on a non-duplication constraint, according to some embodiments. At element 412, in the illustrated embodiment, a number of dither values to be generated for a set of shots (e.g., along a source line in a marine seismic survey) is determined.

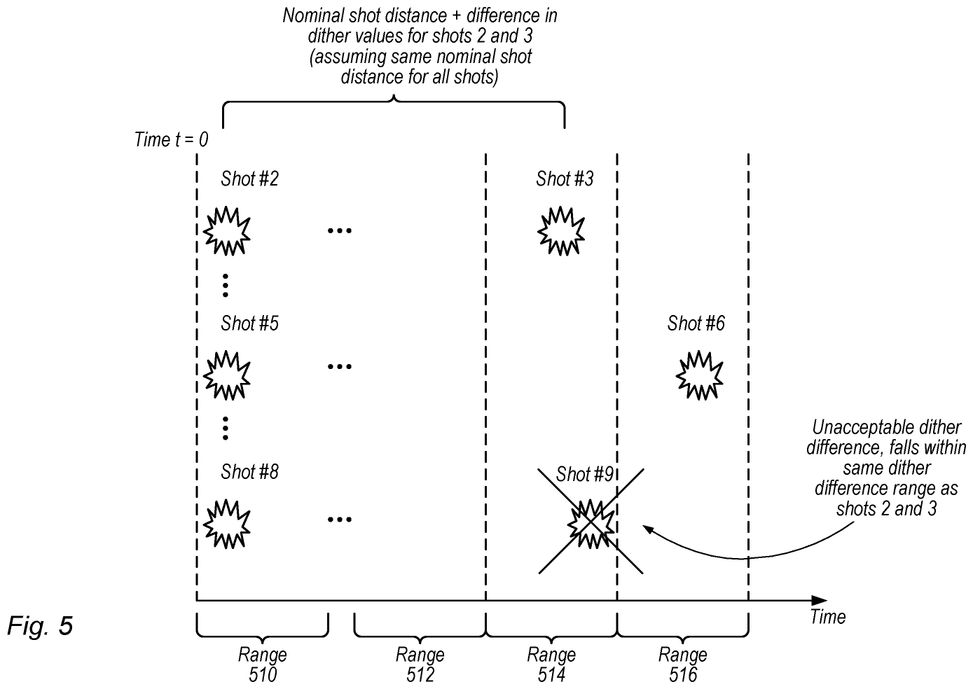

At 414, in the illustrated embodiment, a set of discrete ranges for differences between dither values for consecutive shot points is determined. For example, four discrete 100 ms ranges may include a first range of differences between dither values of 0-25 ms, a second range of 25-50 ms, a third range of 50-75 ms, and a fourth range of 75-100 ms. In some embodiments, at most a threshold number of dither differences (e.g., at most one) for the selected number of dither values are allowed to fall within each discrete range. Continuing the example above, for four dither values for consecutive shots, at most one difference between dither values for consecutive shot points may fall in the first range 0-25 ms. Example ranges are discussed in further detail below with reference to FIG. 5.

At 416, a random dither value for shot N is selected (N indicates the current shot for which a dither value is being generated; the process may iterate through the selected number of dither values). The value may be specified in units of time or distance, for example. The random selection may be performed subject to a constraint that specifies a minimum difference in dither values between consecutive shot points, as shown. In some embodiments, the selection of a random dither value is performed from within some predefined range of a nominal shot point location. For example, dither values may be randomly generated within a 1000 millisecond (ms) time interval following the nominal shot point for shot N. In other embodiments, dithers may be allowed within intervals of various sizes and may fall on both sides of a nominal shot point, for example.

As used herein, the term “random” refers to values that satisfy one or more statistical tests for randomness. In some embodiments, the values are produced using a definite mathematical process, e.g., based on one or more seed values, which may be stored or generated by a computing system. The process for generating random values may ensure a particular distribution over the generated values. It is therefore to be understood that the term “random,” as used herein, includes both pseudo-random techniques and truly random techniques. As one example, for a given range of potential dither values, a process may be considered random if it has a threshold level of unpredictability in selecting dither values within the range. In some embodiments, the values are produced using quasi-random techniques, which includes generating random values subject to one or more distribution constraints. For example, the applied distribution may require a certain spread among randomly generated values.

At 418, the difference between the dither value of the previous shot and the dither value of the current shot is determined. These dither values may be for the same source or for different sources in a set of sources. In some embodiments, this difference is determined using the equation dither of shot[N]−dither of shot[N−1], wherein shot[N−1] is the dither of the immediately previous shot to shot[N]. Note that the sum of the determined difference and the nominal spacing between consecutive shot points corresponds to the difference between actual consecutive shot points. For example, if the nominal spacing between shot points is 5000 ms and the determined dither difference between two shots is 100 ms, then the actual distance between these two shots is 5100 ms.

At decision element 420, a determination is made whether a previously-selected dither difference already falls in the same discrete range. For example, consider an implementation where the ranges are 100 ms (e.g., 100-200 ms, 200-300 ms, 300-400 ms and so on), and a previous dither difference was 224 ms. In this example, a dither difference of 265 ms for the current shot point would not be acceptable because a previous dither difference already fell within the same range (200-300 ms). In the illustrated embodiment, if the range already contains a dither difference, the computing device discards the dither value at element 422 and proceeds to determine a new dither value for the current shot point by returning to element 416. In the illustrated embodiment, if the range is not already occupied, the computing device keeps (e.g., stores) the dither value selected at element 416.

At decision element 426, a determination is made whether the selected number of dither values to be generated for the set of shots has been reached. In the illustrated embodiment, if the selected number of shots has been reached, the process ends at element 428. In the illustrated embodiment, if the selected number of shots has not been reached, the process returns to element 416.

FIG. 4B is a block diagram illustrating an example method for determining dither values for a set of shot points based on a statistical value constraint, according to some embodiments.

At 452, in the illustrated embodiment, a number of dither values to be generated for a set of shots is selected. For example, the selected number of dither values to be generated may be 1000.

At 454, a number of shots for the set of shots is determined. For example, the set of shots may be determined to include 10 shots. At 456 dither values for each shot in the set of shots are generated. For example, a set of 10 dither values may be generated for a set of 10 shots.

At 458 a statistical value for differences between the dither values for the set of shots is determined. In some embodiments, the statistical value is a standard deviation value for dither differences among the set of shots. In other embodiments, other statistical values may be used.

At 460 it is determined whether the determined statistical value equals or exceeds a threshold. For example, the threshold may be a minimum standard deviation value. If the threshold has been met, the flow proceeds to 464 where the dither values for the set of shots are kept. If the predetermined threshold has not been met, the flow proceeds to 462 where the dither values are discarded.

At 466 it is determined whether the selected number of dither values has been reached. If the number of dither values has been reached, the flow ends at 468. If the number of dither values has not been reached, the flow returns to 456 where the process is repeated. In other embodiments, any of various techniques for ending the procedure may be used, e.g., when a threshold number of sets that meet the predetermined threshold have been found.

FIG. 5 illustrates exemplary application of a constraint that differences between consecutive dithers within a set of shot points cannot fall within the same range, according to some embodiments. In the illustrated embodiment, six different dithered shot points are shown (corresponding to shot numbers 2, 3, 5, 6, 8, and 9) for a single seismic energy source. In the illustrated embodiment, shot numbers 2, 5, and 8 are aligned to facilitate comparative illustration of dither differences between these shot numbers and their respective subsequent shots.

In the illustrated embodiment, the distance between shots (e.g., between shots 2 and 3 as shown by the upper bracket in FIG. 5) corresponds to the sum of the nominal shot distance and the difference in dither values for the shots (assuming, for the example, that the same nominal shot distance is used for all shots in the set). For example, assume that the nominal distance between shot number 2 and shot number 3 is 5000 ms and the dither values for shot numbers 2 and 3 are 50 ms and 100 ms, respectively. In this example, the difference in dither values between shot numbers 2 and 3 is 50 ms. Therefore, in this example, the distance between dithered shot numbers 2 and 3 is 5050 ms (nominal shot distance (5000 ms)+difference in dither values (50 ms)), which falls within range 514.

In the illustrated embodiment, an applied constraint dictates that no non-duplicate dither differences, among a set of consecutive shot points, may occur within the same discrete range (e.g., within range 510, 512, 514, or 516). In the illustrated embodiment, the dither difference for shots 5 and 6 is acceptable, according to the applied constraint, because it falls in range 516 which is not occupied by another dithered shot point (assuming this range is not used by the shot points not explicitly shown).

In the illustrated embodiment, assuming the dither difference between shots 2 and 3 has already been assigned, the dither difference for shots 8 and 9 is not acceptable because it falls in the same range 514, according to the applied constraint. This may cause a tentative dither value for shot 9 to be discarded at element 465 of FIG. 4, for example. Note that both positive and negative dither values and differences between dither values are contemplated, although certain examples herein may show only positive values to simplify illustration.

FIG. 6A illustrates example discrete ranges between consecutive shot points according to the constraint discussed with reference to FIG. 5, according to some embodiments. Note that the shots points may be for the same source or for multiple sources in a set of sources. FIG. 6B illustrates example parameters for the shot points of FIG. 6A. In the illustrated example, a 5000 ms difference between nominal shot points is used, and dithers are randomly generated within a 1000 ms interval following each nominal shot point. In the illustrated embodiment, based on the 5000 ms dither difference and the 100 ms time interval, the differences between actual shot times for shot N+1 and shot N fall in the 4500-6000 ms range (in this example, a constraint is applied that consecutive shots can have no less than −500 dither difference, providing a dither value range of −500 to +1000 ms). In the illustrated embodiment, locations of 10 actual shot points are displayed in ones of 100 ms discrete ranges within this range. For this example, the shot points are planned for a vessel velocity of 2.5 meters per second with a 12.5 meter nominal shot point distance. Note that the example configuration is for purposes of illustration and that any of various appropriate nominal distances, allowed dither intervals, discrete range sizes, velocities, number of shot points in a processed set, etc. may be used in other embodiments.

Referring again to FIG. 6A, in the illustrated example, the horizontal axis represents the dithered shot point number, while the vertical axis represents the time differences, in milliseconds, between actual consecutive shot points in a set of ten shot points. For example, the dot for shot number 2 shows the time distance between shot 2 and shot number 3. Given the 5000 ms nominal interval, actual distances closer to 5000 ms have smaller absolute dither differences than actual distances further from 5000 ms.

As shown, each of the differences between consecutive dithers within the set of shot points falls within a distinct one of the 100 ms ranges for the set of 10 example shot points. In some embodiments, this technique is one specific way to achieve a desired standard deviation for dither differences for the set of shot points (although other techniques may be used to achieve desired standard deviation, in other embodiments). As one example of an alternative technique for achieving a desired standard deviation, in some embodiments multiple sets of dither values are randomly generated for a given survey, and only one or more sets that meet a standard deviation constraint for sets of shot points are actually selected for use in the survey. Note that a threshold absolute dither difference constraint may also be applied to each set for this random generation of multiple sets of dither values.

The difference between dither values for two consecutive shots in a survey may be calculated using various different techniques. As a first technique, the dither value for a first shot may be subtracted from the dither value of a second consecutive shot. As a second technique, the actual shot position for the first shot and the nominal distance between shots may be subtracted from the actual shot position of the second consecutive shot to achieve an equivalent result. Note that the dither values and shot positions may be specified in units of distance or time. The relationship between dither duration and distance may be based on the velocity of the sources relative to the ground. Various other types of calculations may also be performed to determine dither difference.

In some embodiments, multiple dither value tables (e.g., sets of dither values) are generated according to one or more of the constraints discussed above. Note that one or more of these dither value tables may be generated or selected based on a survey vessel velocity (e.g., a current velocity or a planned future velocity). A planned survey vessel velocity may be determined before or during the actual seismic survey. In other embodiments, multiple dither value tables are selected and used during the course of an actual seismic survey (e.g., when the vessel velocity varies for different portions of a survey pass).

Exemplary Plots with Dithering Constraints

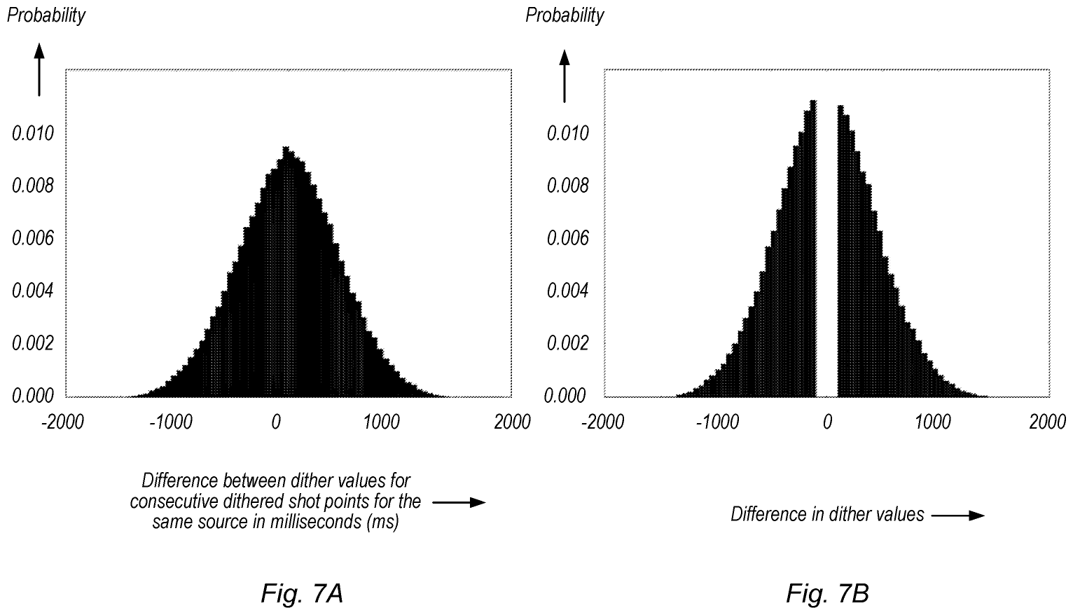

FIGS. 7A and 7B illustrate exemplary probability plots for differences between dither values for consecutive shot points with and without a constraint that absolute differences are greater than a threshold value, respectively. In the illustrated examples, the horizontal axis represents the difference between dither values for consecutive dithered shot points for the same source in milliseconds. In the illustrated examples, the vertical axis represents the probability that a shot will occur having a certain difference in dither value with respect to the previous consecutive shot point.

In the example of FIG. 7A, no constraints have been applied to the consecutive shot points, other than a nominal distance and acceptable dither range. In the illustrated embodiment, the distribution of the histogram is centered around a zero-dither difference. Note that source separation may be more difficult for dither differences falling closer to zero dither difference. Said another way, differences between shot points that are very close to the nominal difference may be undesirable.

In FIG. 7B, a threshold absolute dither difference constraint has been applied. In the illustrated embodiment, the difference between consecutive dither values reflects the constraint that the time difference between consecutive shot points must be greater than a threshold value, where the threshold value is 50 ms. In the illustrated embodiment, according to the applied constraint, the differences in dither values for consecutive shot points do not fall within the −50 ms to 50 ms range. Note that any of various appropriate threshold values may be used in other embodiments. In some embodiments, the threshold absolute dither difference constraint exhibited in FIG. 7B may improve source separation techniques.

FIG. 8 illustrates an exemplary probability plot for differences between consecutive dithered shot points with both a dither difference constraint and a standard deviation constraint applied, according to some embodiments. In the illustrated embodiment, the probability is shown on the vertical axis and the dither value difference is shown on the horizontal axis (similarly to FIGS. 7A and 7B).

In the illustrated example, the dither difference constraint is subject to the same threshold (e.g., 50 ms) as in FIG. 7B. In the illustrated example, a threshold standard deviation of 600 ms is implemented for sets of 10 shot points. In some embodiments, a larger (or smaller) threshold standard deviation is used. In embodiments where a larger threshold standard deviation is used, the histogram may display a flatter distribution. In some embodiments, the constraint exhibited in FIG. 8 may improve source separation techniques.

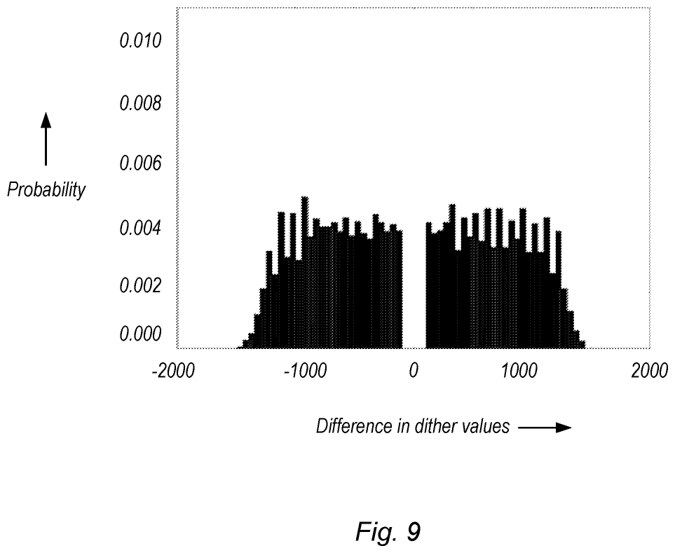

FIG. 9 illustrates an exemplary probability plot for differences between consecutive dithered shot points with both a dither difference constraint and a non-duplication constraint applied, according to some embodiments. In the illustrated embodiment, the probability is shown on the vertical axis and the dither value difference is shown on the horizontal axis (similarly to FIGS. 7A, 7B, and 8). Note that the number of dither values used to generate this exemplary histogram is less than the number of values used for FIGS. 7A,7B, and 8, generating a less smooth distribution than FIG. 8, for example. In some embodiments, the constraint exhibited in FIG. 9 may improve source separation techniques.

In the illustrated example, this constraint specifies that there are no repeated/duplicate dither differences in discrete 100 ms ranges for 23 consecutive shot points. Said another way, in the illustrated example, for sets of 23 shot points there may only be one shot point within each 100 ms range. In some embodiments, application of one or more of the disclosed constraints may improve deblending performance during seismic imaging based on measured sensor data. For example, the disclosed techniques may avoid small differences in dither values and similar differences in dither values among shot points from a set of sources. The measured sensor data from a range of dither difference values may facilitate deblending relative to sensor data where dither differences overlap. In some embodiments, this may advantageously improve imaging performance and/or improve image accuracy.

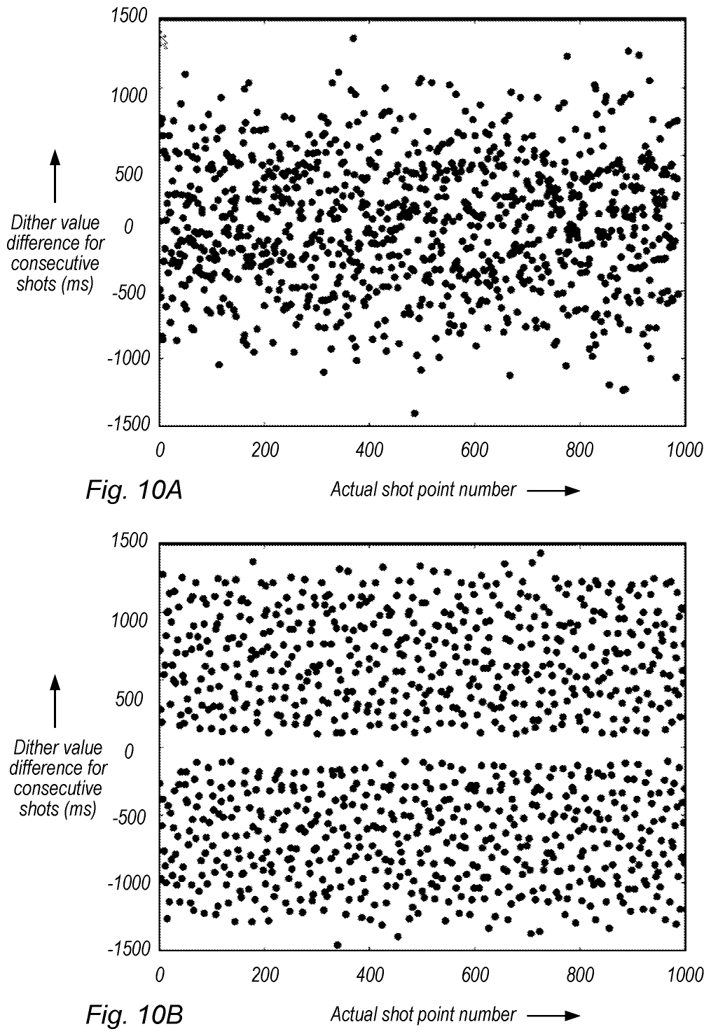

FIGS. 10A and 10B illustrate exemplary plots of the difference in dither values between consecutive shot points for a single source when no constraints are applied and when multiple constraints are applied, respectively, according to some embodiments. In the illustrated examples, the vertical axis is the dither value difference for consecutive shot points (similar to FIGS. 7A-9) and the horizontal axis is the actual shot point number (e.g., shot #1 through shot #1000). Note that these plots represent similar information as in the plot of FIG. 6A, but with greater numbers of shot points plotted.

In the example of FIG. 10A, no constraints are applied. In the illustrated example, 1000 shot points are shown with dither value differences for consecutive shots ranging from −1500 ms to 1500 ms. In the example of FIG. 10B, multiple constraints are applied including at least a dither value absolute difference threshold of 50 ms and a standard deviation threshold. Both of these constraints are visible in the shot points of FIG. 10B, relative to the shot points of FIG. 10A. As discussed above, the improved distribution seen in FIG. 10B of the dither value differences may improve de-blending techniques in processing recorded signals, which may in turn improve seismic imaging.

### Exemplary Methods

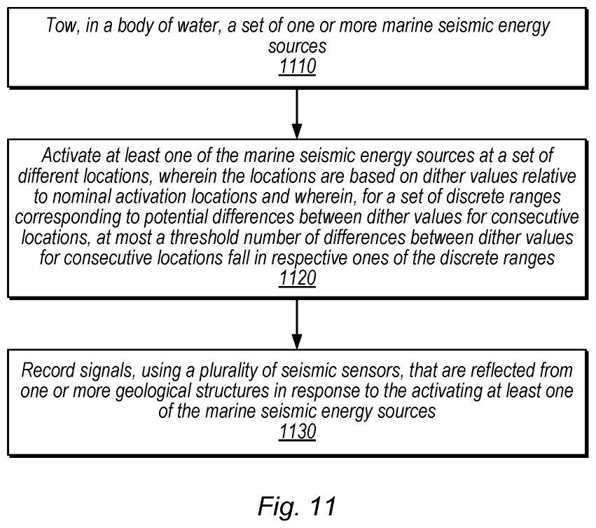

FIG. 11 is an exemplary method for performing a marine seismic survey using a set of dither values that exhibit a non-duplication characteristic for dither values of consecutive shot points, according to some embodiments. The method shown in FIG. 11 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 1110, in the illustrated embodiment, a survey vessel tows, in a body of water, a set of one or more marine seismic energy sources.

At 1120, in the illustrated embodiment, the survey vessel activates at least one of the marine seismic energy sources at a set of different locations, where the locations are based on dither values relative to nominal activation locations and where, for a set of discrete ranges corresponding to potential differences between dither values for consecutive locations, at most a threshold number of differences between dither values for consecutive locations fall in respective ones of the discrete ranges. In some embodiments, the threshold number of differences between dither values for consecutive locations is one.

At 1130, in the illustrated embodiment, the survey vessel records signals, using a plurality of seismic sensors, that are reflected from one or more geological structures in response to the activation of the marine seismic energy source.

In some embodiments, the absolute differences between dither values for consecutive locations in the set of locations meet a threshold value. In some embodiments, the computing device selects a set of dither values from among a plurality of available sets of dither values based on a velocity of the set of marine seismic energy sources relative to the ground. In some embodiments, ones of the available sets of dither values have at most a threshold number of differences between consecutive dither values within different sizes of discrete ranges. In some embodiments, the survey vessel stores the recorded signals on a tangible, computer-readable medium, thereby completing the manufacture of a geophysical data product.

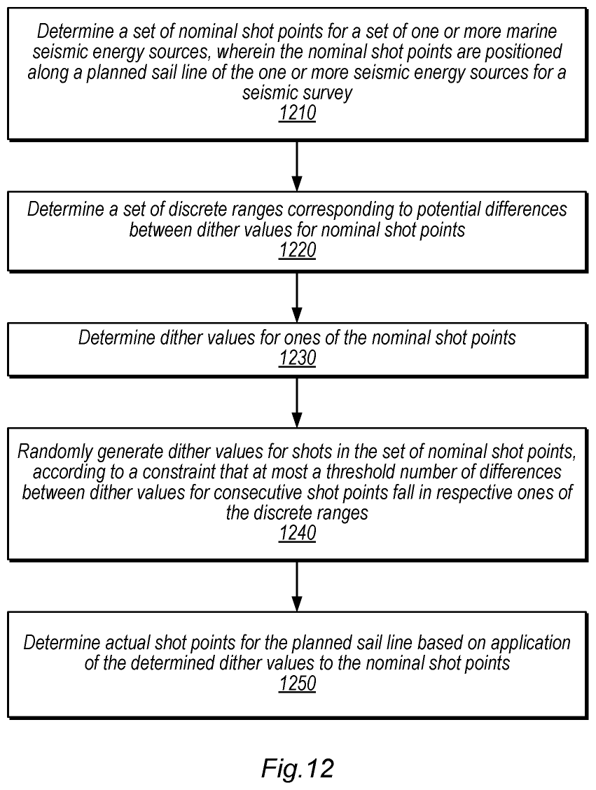

FIG. 12 is an exemplary method for determining one or more dither values for a set of nominal shot points based on a duplication constraint, according to some embodiments. The method shown in FIG. 12 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 1210, in the illustrated embodiment, a computing device determines a set of nominal shot points for set of one or more a marine seismic energy sources, wherein the nominal shot points are positioned along a planned sail line of the one or more seismic energy sources for a seismic survey.

At 1220, in the illustrated embodiment, the computing device determines a set of discrete ranges corresponding to potential differences between dither values for nominal shot points.

At 1230, in the illustrated embodiment, the computing device determines dither values for ones of the nominal shot points.

At 1240, in the illustrated embodiment, the computing device randomly generates dither values for shots in the set of nominal shot points, according to a constraint that at most a threshold number of differences between dither values for consecutive shot points fall in respective ones of the discrete ranges.

In some embodiments, the threshold number of differences between dither values for consecutive locations is one. In some embodiments, the computing device randomly generates dither values subject to a constraint that absolute differences between dither values for consecutive shot points are greater than a threshold value.

In some embodiments, the computing device determines the threshold value for the absolute differences between dither values for consecutive shot points based on a threshold signal frequency to be emitted by the set of one or more seismic energy sources. In some embodiments, the computing device generates a plurality of dither tables with different sizes of discrete ranges, where the plurality of dither tables are configured for different source velocities over the ground. In some embodiments, the computing device selects one or more of the generated dither tables based on a planned velocity within one or more survey passes of the seismic survey. In surveys with multiple sources, different sources may use the same table of dither values or different tables of dither values during operation.

In various embodiments, element 1230 alone, in combination with the other operations of FIG. 12, or in combination with operations different from those illustrated in FIG. 12 corresponds to various means for randomly generating dither values subject to a constraint that at most a threshold number of differences between dither values for a consecutive shot points are within different sizes of discrete ranges. FIG. 4 elements 420-460 are also examples of such means.

At 1240, in the illustrated embodiment, the computing device determines actual shot points for the planned sail line based on application of the determined dither values to the nominal shot points.

Note that, in some embodiments, a planned velocity for the sources is determined prior to performing the survey (e.g., planned on a computing device at a time prior to when the survey is performed). In other embodiment, the planned velocity for the survey vessel is a dynamic planned velocity, where the velocity is determined while the survey is being performed (e.g., during the survey).

As discussed above, the disclosed techniques may facilitate a de-blending procedure which may improve seismic imaging. Note, however, that facilitating a separate de-blending procedure does not require actually performing the de-blending procedure. For example, actual shot points for a sail line may be determined without performing the de-blending procedure for recorded signals. In some scenarios, however, the same entity may both determine actual shot points from the determined dither values and also perform the de-blending procedure for the survey.

### Example Computing System

Various operations described herein may be implemented by a computing device configured to execute program instructions that specify the operations. Similarly, various operations may be performed by circuitry designed or configured to perform the operations. In some embodiments, a non-transitory computer-readable medium has program instructions stored thereon that are capable of causing various operations described herein. As used herein, the term “processor,” “processing unit,” or “processing element” refers to various elements or combinations of elements configured to execute program instructions. Processing elements include, for example, circuits such as an ASIC (Application Specific Integrated Circuit), custom processing circuits or gate arrays, portions or circuits of individual processor cores, entire processor cores, individual processors, programmable hardware devices such as a field programmable gate array (FPGA) or the like, and/or larger portions of systems that include multiple processors, as well as any combinations thereof.

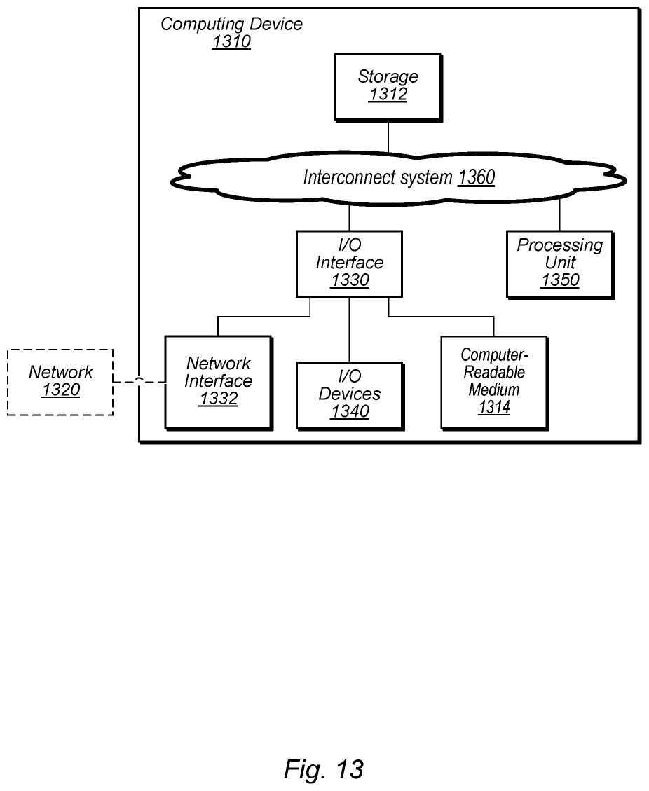

Turning now to FIG. 13, a block diagram of a computing device (which may also be referred to as a computing system) 1310 is depicted, according to some embodiments. Computing device 1310 may be used to implement various portions of this disclosure. Computing device 1310 is one example of a device that may be used as a mobile device, a server computing system, control equipment, a client computing system, or any other computing system implementing portions of this disclosure.

Computing device 1310 may be any suitable type of device, including, but not limited to, a personal computer system, desktop computer, laptop or notebook computer, mobile phone, mainframe computer system, web server, workstation, or network computer. As shown, computing device 1310 includes processing unit 1350, storage subsystem 1312, and input/output (I/O) interface 1330 coupled via interconnect 1360 (e.g., a system bus). I/O interface 1330 may be coupled to one or more I/O devices 1340. I/O interface 1330 may also be coupled to network interface 1332, which may be coupled to network 1320 for communications with, for example, other computing devices. I/O interface 1330 may also be coupled to computer-readable medium 1314, which may store various survey data such as sensor measurements, survey control parameters, etc.

As described above, processing unit 1350 includes one or more processors. In some embodiments, processing unit 1350 includes one or more coprocessor units. In some embodiments, multiple instances of processing unit 1350 may be coupled to interconnect system 1360. Processing unit 1350 (or each processor within processing unit 1350) may contain a cache or other form of on-board memory. In some embodiments, processing unit 1350 may be implemented as a general-purpose processing unit, and in other embodiments it may be implemented as a special purpose processing unit (e.g., an ASIC). In general, computing device 1310 is not limited to any particular type of processing unit or processor subsystem.

Storage subsystem 1312 is usable by processing unit 1350 (e.g., to store instructions executable by and data used by processing unit 1350). Storage subsystem 1312 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on.

Storage subsystem 1312 may consist solely of volatile memory in some embodiments. Storage subsystem 1312 may store program instructions executable by computing device 1310 using processing unit 1350, including program instructions executable to cause computing device 1310 to implement the various techniques disclosed herein. In at least some embodiments, storage subsystem 1312 may represent an example of a non-transitory computer-readable medium that may store executable instructions.

In the illustrated embodiment, computing device 1310 further includes non-transitory medium 1314 as a possibly distinct element from storage subsystem 1312. For example, non-transitory medium 1314 may include persistent, tangible storage such as disk, nonvolatile memory, tape, optical media, holographic media, or other suitable types of storage. In some embodiments, non-transitory medium 1314 may be employed to store and transfer geophysical data and may be physically separable from computing device 1310 to facilitate transport. Accordingly, in some embodiments, the geophysical data product discussed above may be embodied in non-transitory medium 1314. Although shown to be distinct from storage subsystem 1312, in some embodiments, non-transitory medium 1314 may be integrated within storage subsystem 1312.

I/O interface 1330 may represent one or more interfaces and may be any of various types of interfaces configured to couple to and communicate with other devices, according to various embodiments. In some embodiments, I/O interface 1330 is a bridge chip from a front-side to one or more back-side buses. I/O interface 1330 may be coupled to one or more I/O devices 1340 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.). In some embodiments, the geophysical data product discussed above may be embodied within one or more of I/O devices 1340.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

It is to be understood the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents (such as “one or more” or “at least one”) unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Moreover, where flow charts or flow diagrams are used to illustrate methods of operation, it is specifically contemplated that the illustrated operations and their ordering demonstrate only possible implementations and are not intended to limit the scope of the claims. It is noted that alternative implementations that include more or fewer operations, or operations performed in a different order than shown, are possible and contemplated.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Although various advantages of this disclosure have been described, any particular embodiment may incorporate some, all, or even none of such advantages.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims, and features from respective independent claims may be combined in any appropriate manner and not merely in the specific combinations enumerated in the appended claims.

1. A method for generating dither values corresponding to source activations to be performed during a marine seismic survey, the method comprising:
determining a set of nominal shot points corresponding to a set of sources to be used during a portion of the survey; and
determining a set of dither values, each dither value in the set specifying a difference between one of the nominal shot points and an actual shot point to be produced by the set of sources during the survey;
wherein determining the set of dither values comprises satisfying one or more constraints chosen from the group consisting of: an absolute dither difference constraint, a non-duplication constraint, and a standard deviation constraint;
wherein each of the one or more constraints is based on differences between dither values corresponding to consecutive ones of the nominal shot points, wherein each such difference comprises a dither difference, such that:
satisfying the absolute dither difference constraint comprises ensuring that each dither difference corresponding to the set of dither values is greater than a threshold dither difference;
satisfying the non-duplication constraint comprises ensuring that, for a given set of discrete ranges of dither difference values, at most a threshold number of dither differences corresponding to the set of dither values falls within any one of the ranges; and
satisfying the standard deviation constraint comprises ensuring that the standard deviation of dither differences corresponding to the set of dither values is greater than a threshold standard deviation.

2. The method of claim 1, wherein the set of sources consists of one source.

3. The method of claim 1, wherein the portion of the survey consists of one sail line.

4. The method of claim 1, wherein the dither values comprise units of distance.

5. The method of claim 1, wherein the dither values comprise units of time.

6. The method of claim 1, further comprising satisfying two or more of the constraints.

7. The method of claim 1, wherein each of the discrete ranges corresponds to a 1000 ms interval.

8. The method of claim 1, wherein each of the discrete range corresponds to a 100 ms interval.

9. The method of claim 1, wherein each of the discrete ranges corresponds to a 25 ms interval.

10. The method of claim 1, further comprising determining the threshold dither difference based on a threshold frequency to be emitted by the one or more sources during the survey.

11. The method of claim 10, wherein the threshold dither difference is equal to one half of a cycle period corresponding to the threshold frequency.

12. The method of claim 1, wherein the threshold number of dither differences that may fall into any one of the ranges is 1.

13. The method of claim 1, wherein the dither differences are absolute values such that negative and positive dither differences are treated as having the same sign.

14. The method of claim 1, wherein determining the set of dither values further comprises:
A) generating one or more dither values randomly;
B) determining whether the dither values generated randomly satisfy one or more of the constraints; and
C) repeating steps A and B until the dither values generated randomly satisfy one or more of the constraints.

15. The method of claim 1, further comprising storing the set of dither values in a tangible computer-readable medium.

16. The method of claim 1, further comprising applying the set of dither values to the set of nominal shot points to produce a set of actual shot points for use during the survey.

17. The method of claim 16, further comprising storing the set of actual shot points in a tangible computer-readable medium.

18. A tangible computer-readable medium having instructions stored therein that, when executed by a computing device, cause the computing device to perform a method for generating dither values corresponding to source activations to be performed during a marine seismic survey, the method comprising:
accessing a set of nominal shot points corresponding to a set of sources to be used during a portion of the survey; and
determining a set of dither values, each dither value in the set specifying a difference between one of the nominal shot points and an actual shot point to be produced by the set of sources during the survey;
wherein determining the set of dither values comprises satisfying one or more constraints chosen from the group consisting of: an absolute dither difference constraint, a non-duplication constraint, and a standard deviation constraint; and
wherein each of the one or more constraints is based on differences between dither values corresponding to consecutive ones of the nominal shot points, wherein each such difference comprises a dither difference, such that:
satisfying the absolute dither difference constraint comprises ensuring that each dither difference corresponding to the set of dither values is greater than a threshold dither difference;
satisfying the non-duplication constraint comprises ensuring that, for a given set of discrete ranges of dither difference values, at most a threshold number of dither differences corresponding to the set of dither values falls within any one of the ranges; and
satisfying the standard deviation constraint comprises ensuring that the standard deviation of dither differences corresponding to the set of dither values is greater than a threshold standard deviation.

19. A method for performing a marine seismic survey, comprising:
activating one or more sources at a plurality of actual shot points, wherein each of the actual shot points differs from a corresponding nominal shot point by a dither value;
wherein differences between dither values corresponding to consecutive ones of the nominal shot points constitute dither differences; and
wherein a set of dither values corresponding to a portion of the survey satisfies one or more constraints chosen from the group consisting of: an absolute dither difference constraint, a non-duplication constraint, and a standard deviation constraint; such that:
satisfying the absolute dither difference constraint comprises ensuring that each dither difference corresponding to the set of dither values is greater than a threshold dither difference;
satisfying the non-duplication constraint comprises ensuring that, for a given set of discrete ranges of dither difference values, at most a threshold number of dither differences corresponding to the set of dither values falls within any one of the ranges; and
satisfying the standard deviation constraint comprises ensuring that the standard deviation of dither differences corresponding to the set of dither values is greater than a threshold standard deviation.

20. The method of claim 19, further comprising:
recording signals registered by geophysical sensors responsive to activations of the one or more sources; and
storing the signals in a tangible computer-readable medium, thereby completing the manufacture of a geophysical data product.

21. A non-transitory computer-readable medium having instructions stored therein that, when executed by a computing device on a marine seismic survey vessel, cause equipment associated with the vessel to perform a marine seismic survey, the survey comprising:
activating one or more sources at a plurality of actual shot points, wherein each of the actual shot points differs from a corresponding nominal shot point by a dither value;
wherein differences between dither values corresponding to consecutive ones of the nominal shot points constitute dither differences; and
wherein a set of dither values corresponding to a portion of the survey satisfies one or more constraints chosen from the group consisting of: an absolute dither difference constraint, a non-duplication constraint, and a standard deviation constraint; such that:
satisfying the absolute dither difference constraint comprises ensuring that each dither difference corresponding to the set of dither values is greater than a threshold dither difference;
satisfying the non-duplication constraint comprises ensuring that, for a given set of discrete ranges of dither difference values, at most a threshold number of dither differences corresponding to the set of dither values falls within any one of the ranges; and
satisfying the standard deviation constraint comprises ensuring that the standard deviation of dither differences corresponding to the set of dither values is greater than a threshold standard deviation.

22. The method of claim 1:
wherein determining the set of dither values comprises satisfying all three of the constraints.

23. The method of claim 22:
wherein the portion of the survey comprises one sail line.

24. The medium of claim 18:
wherein determining the set of dither values comprises satisfying all three of the constraints.

25. The medium of claim 24:
wherein the portion of the survey comprises one sail line.

26. The method of claim 20:
wherein the set of dither values satisfies all three of the constraints.

27. The medium of claim 26:
wherein the portion of the survey comprises one sail line.

28. The medium of claim 21:
wherein the set of dither values satisfies all three of the constraints.

29. The medium of claim 28:
wherein the portion of the survey comprises one sail line.
